(19) United States
(12) Patent Application Publication
(10) Pub. No.: US 2021/0152548 A1
(43) Pub. Date: May 20, 2021

(54) AUTHENTICATION SYSTEM AND SERVER

(71) Applicant: KABUSHIKI KAISHA SEGA GAMES DOING BUSINESS AS SEGA GAMES CO., LTD., Shinagawa-ku, Tokyo (JP)

(72) Inventors: Satoshi MOTOIKE, Ohta-ku, Tokyo (JP); Shin ISHIKAWA, Ohta-ku, Tokyo (JP); Hideo SASAKI, Ohta-ku, Tokyo (JP); Yoshihiro OKABAYASHI, Ohta-ku, Tokyo (JP); Yoshiki MATSUSHITA, Ohta-ku, Tokyo (JP)

(21) Appl. No.: 16/637,687

(22) PCT Filed: Sep. 29, 2017
(86) PCT No.: PCT/JP2017/035596

§ 371 Date: Feb. 7, 2020

(30) Foreign Application Priority Data
Aug. 7, 2017 (JP) 2017-152672

(51) Int. Cl. H04L 29/06

(52) U.S. Cl. CPC H04L 63/0861

(57) ABSTRACT

It is an object of the present invention to shorten the waiting time until a verification device in a usage facility is actually used.

The present invention is a verification system with a verification device, said verification system comprising a server and a verification device, the server comprises a storage unit that stores user information in which biometric data for identifying individuals has been preset in association with each user, a user selector that selects a user located in the usage facility from among the plurality of users included in the user information, and a communication unit that transmits biometric data associated with the selected user via a communication network to the verification device in the usage facility where the biometric verification is to be performed, and the verification device comprises a device communication unit that receives biometric data associated with the user selected by the user selector via the communication network, a verification data input unit that acquires biometric data about the user located in the usage facility, and a user verification unit that performs biometric verification by comparing the biometric data received by the device communication unit with the biometric data acquired by the verification data input unit.

### TECHNICAL FIELD

The present invention relates to a verification system and a server.

### BACKGROUND ART

There are known verification systems that perform user verification by having a verification device in a usage facility read identification data stored on a non-contact IC card in the possession of a user in a usage facility used by many users (Patent Document 1, for example).

### PRIOR ART DOCUMENT

### Patent Documents

Patent Document 1: JP-A147945

### SUMMARY OF THE INVENTION

### Problems to be Solved by the Invention

With such a verification system, the verification device in the usage facility receives the verification data from a server via a network after reading the identification data on a non-contact IC card, so it takes some time for the user verification to be completed, and the waiting time until the verification device in the usage facility can actually be used ends up being long.

The present invention was conceived in light of this situation, and it is an object thereof to shorten the waiting time until a verification device in a usage facility can actually be used.

### Means for Solving Problem

The main invention of the present invention for solving the stated problems is:

A verification system for performing biometric verification with a verification device in a usage facility, said verification system comprising a server and a verification device,

the server comprising:

a storage unit that stores user information in which biometric data for identifying individuals has been preset in association with each user;

a user selector that selects a user located in the usage facility from among multiple users included in the user information, when a user terminal in the possession of a user who has entered the usage facility is connected with a communication network so as to allow the exchange of information; and

a communication unit that acquires biometric data associated with the selected user from the user information and transmits this data via the communication network to the verification device in the usage facility where the biometric verification is to be performed, and

the verification device comprising:

a device communication unit that receives biometric data associated with the user selected by the user selector from the server via the communication network;

a verification data input unit that acquires biometric data about the user located in the usage facility; and

a user verification unit that performs biometric verification by comparing the biometric data received by the device communication unit with the biometric data acquired by the verification data input unit.

Other features of the present invention will become apparent from the description of this specification and the accompanying drawings.

### BRIEF DESCRIPTION OF DRAWINGS

FIG. 1 A network configuration diagram showing an example of a verification system 1 according to a first embodiment.

FIG. 2 A block diagram of the functional configuration of a server 10 according to the first embodiment.

FIG. 3 A diagram showing an example of the data structure of user information.

FIG. 4 A diagram showing an example of the data structure of history information.

FIG. 5 A diagram showing an example of the data structure of facility information.

FIG. 6 A diagram showing an example of the data structure of device information.

FIG. 7 A block diagram showing the functional configuration of a vending machine 20 according to the first embodiment.

FIG. 8 A block diagram showing the functional configuration of a user terminal 50 according to the first embodiment.

FIG. 9 A flowchart illustrating the processing related to the selection of users who have entered a shopping facility 3.

FIG. 10 A flowchart illustrating the processing related to the selection of users who are in the vicinity of the vending machine 20 in the facility.

FIG. 11 A flowchart illustrating the processing related to user verification.

FIG. 12 A network configuration diagram showing an example of the verification system 1 according to a second embodiment.

FIG. 13 A block diagram showing the functional configuration of a POS terminal 20A according to the second embodiment.

FIG. 14 A flowchart illustrating the processing related to user verification.

FIG. 15 A network configuration diagram showing an example of the verification system 1 according to a third embodiment.

FIG. 16 A block diagram showing the functional configuration of a check-in device 20B according to the third embodiment.

FIG. 17 A flowchart illustrating the processing related to user verification.

### DETAILED DESCRIPTION OF THE INVENTION

At least the following will become apparent from the description of this specification and the accompanying drawings.

Specifically, the present invention is a verification system for performing biometric verification with a verification device in a usage facility, said verification system comprising a server and a verification device,

the server comprising:

a storage unit that stores user information in which biometric data for identifying individuals has been preset in association with each user;

a user selector that selects a user located in the usage facility from among multiple users included in the user information, when a user terminal in the possession of a user who has entered the usage facility is connected with a communication network so as to allow the exchange of information; and

a communication unit that acquires biometric data associated with the selected user from the user information and transmits this data via the communication network to the verification device in the usage facility where the biometric verification is to be performed, and

the verification device comprising:

a device communication unit that receives biometric data associated with the user selected by the user selector from the server via the communication network;

a verification data input unit that acquires biometric data about the user located in the usage facility; and

a user verification unit that performs biometric verification by comparing the biometric data received by the device communication unit with the biometric data acquired by the verification data input unit.

With a verification system such as this, when identifying the users who will actually undergo biometric verification with a verification device within the usage facility, a search may be performed not for all of the users included in the user information, but only for a portion of the users narrowed down from among all the users included in the user information (those users located in the selected usage facility), so biometric verification can be completed more quickly. As a result, it is possible to shorten the waiting time until a verification device in the usage facility can actually be used.

The present invention is also a verification system for performing biometric verification with a verification device in a usage facility, said verification system comprising a server and a verification device,

the server comprising:

a storage unit that stores user information in which biometric data for identifying individuals has been preset in association with each user;

a user selector that selects a user in the vicinity of the verification device from among the plurality of users included in the user information, when a user terminal in the possession of a user in the vicinity of a verification device in the usage facility is connected with a communication network so as to allow the exchange of information; and

a communication unit that acquires biometric data associated with the selected user from the user information and transmits this data via the communication network to the verification device in the usage facility where the biometric verification is to be performed, and

the verification device comprising:

a device communication unit that receives biometric data associated with the user selected by the user selector from the server via the communication network;

a verification data input unit that acquires biometric data about the user the verification device; and

a user verification unit that performs biometric verification by comparing the biometric data received by the device communication unit with the biometric data acquired by the verification data input unit.

With a verification system such as this, when identifying the users who will actually undergo biometric verification with a verification device within the usage facility, a search may be performed not for all of the users included in the user information, but only for a portion of the users narrowed down from among all the users included in the user information (those users in the vicinity of the selected verification device), so biometric verification can be completed more quickly. As a result, it is possible to shorten the waiting time until a verification device in the usage facility can actually be used.

The present invention is also a verification system for performing biometric verification with a verification device in a usage facility, said verification system comprising a server and a verification device,

the server comprising:

a storage unit that stores user information in which biometric data for identifying individuals has been preset in association with each user;

a user selector that selects a user located in the usage facility from among the users included in the user information, when a user terminal in the possession of a user who has entered a facility area corresponding to the usage facility is connected with a communication network so as to allow the exchange of information, and selects a user in the vicinity of the verification device from among the previously selected users located in the usage facility, when a user terminal in the possession of a user who has entered a device area corresponding to a verification device in the usage facility is connected with a communication network so as to allow the exchange of information; and

a communication unit that acquires biometric data associated with the user selected by the user selector from the user information and transmits this data via the communication network to the verification device in the usage facility where the biometric verification is to be performed, and

the verification device comprising:

a device communication unit that receives biometric data associated with the user selected by the user selector from the server via the communication network;

a verification data input unit that acquires biometric data about the user in the vicinity of the verification device; and

a user verification unit that performs biometric verification by comparing the biometric data received by the device communication unit with the biometric data acquired by the verification data input unit.

With a verification system such as this, when identifying the users who will actually undergo biometric verification with a verification device in the usage facility, a search may be performed not for all of the users included in the user information, but only for a portion of the users narrowed down in steps from among all the users included in the user information (those users in the vicinity of the selected verification device), so biometric verification can be completed more quickly. As a result, it is possible to shorten the waiting time until a verification device in the usage facility can actually be used.

Also, with this verification system, the communication unit may transmit the biometric data acquired from the user information before biometric verification is performed by the verification device.

With a verification system such as this, when biometric verification is actually performed with a verification device in the usage facility, since biometric data associated with that user has been acquired by the verification device in advance, biometric verification can be completed more quickly.

Also, with this verification system,

history information related to the verification devices used by users in the past may be associated with each user and included in the user information stored by the storage unit,

the user selector may select a user who has used the verification device in the past from among users located in the selected usage facility or users in the vicinity of verification device in the selected usage facility, and

the communication unit may acquire biometric data associated with users who have used the selected verification device in the past from the user information, and transmit this data via the communication network to the verification device where the biometric verification is to be performed.

With a verification system such as this, when identifying the users who will actually undergo biometric verification with a verification device in the usage facility, a search can be performed that is narrowed down to users who are more likely to actually use that verification device from the past usage status, so biometric verification can be completed more quickly.

Also, with this verification system,

the storage unit may store device information in which a user's usage status is set in association with each verification device, and

the communication unit may transmit the biometric data acquired from the user information on the basis of the usage status of the verification device.

With a verification system such as this, data can be efficiently transmitted according to an available status in which the verification device is not being used.

The present invention is also a server comprising:

a storage unit that stores user information in which biometric data for identifying individuals has been preset in association with each user;

a user selector that selects a user located in the usage facility from among the plurality of users included in the user information, when a user terminal in the possession of a user who has entered the usage facility is connected with a communication network so as to allow the exchange of information; and

a communication unit that acquires biometric data associated with the selected user from the user information and transmits this data via the communication network to the verification device in the usage facility where the biometric verification is to be performed.

With a server such as this, biometric data about a portion of the users narrowed down from all the users included in the user information (those users who are located in the selected usage facility) is transmitted to the verification device in the usage facility where the biometric verification is to be performed, so biometric verification can be completed more quickly. As a result, it is possible to shorten the waiting time until a verification device in the usage facility can actually be used.

The present invention is also a server comprising:

a storage unit that stores user information in which biometric data for identifying individuals has been preset in association with each user;

a user selector that selects a user in the vicinity of the verification device from among users included in the user information, when a user terminal in the possession of a user in the vicinity of a verification device in the usage facility is connected with a communication network so as to allow the exchange of information; and

a communication unit that acquires biometric data associated with the selected user from the user information and transmits this data via the communication network to the verification device in the usage facility where the biometric verification is to be performed.

With a server such as this, biometric data about a portion of the users narrowed down from all the users included in the user information (those users who are in the vicinity of the selected verification device) is transmitted to the verification device in the usage facility where the biometric verification is to be performed, so biometric verification can be completed more quickly. As a result, it is possible to shorten the waiting time until a verification device in the usage facility can actually be used.

The present invention is also a server comprising:

a storage unit that stores user information in which biometric data for identifying individuals has been preset in association with each user;

a user selector that selects a user located in the usage facility from among the users included in the user information, when a user terminal in the possession of a user who has entered a facility area corresponding to the usage facility is connected with a communication network so as to allow the exchange of information, and selects a user in the vicinity of the verification device from among the previously selected users located in the usage facility, when a user terminal in the possession of a user who has entered a device area corresponding to a verification device in the usage facility is connected with a communication network so as to allow the exchange of information; and

a communication unit that acquires biometric data associated with the user in the vicinity of the selected verification device from the user information and transmits this data via the communication network to the verification device where the biometric verification is to be performed.

With a server such as this, biometric data about a portion of the users narrowed down in steps from all the users included in the user information (those users who are in the vicinity of the selected verification device) is transmitted to the verification device in the usage facility where the biometric verification is to be performed, so biometric verification can be completed more quickly. As a result, it is possible to shorten the waiting time until a verification device in the usage facility can actually be used.

### First Embodiment

The first embodiment gives a specific description of an example of a verification system for performing biometric verification at a vending machine as an example of a verification device in a shopping facility as an example of a usage facility.

Configuration of Verification System 1

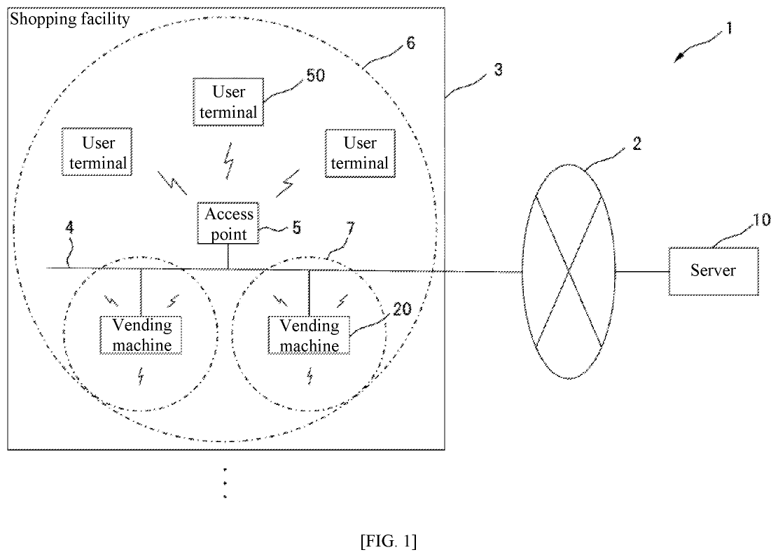

FIG. 1 is a network configuration diagram showing an example of a verification system 1 according to the first embodiment.

In the verification system 1 according to the first embodiment, a user who has entered the shopping facility 3 can purchase a product that matches the user's preference from the vending machine 20 after first performing biometric verification with the vending machine 20 in that facility.

With the verification system 1 according to the first embodiment, a server 10, one or more vending machines 20 installed in one or more shopping facilities 3, and the user terminals 50 of one or more users who have entered those shopping facilities 3 are connected so as to allow the exchange of information via a network.

The server 10 manages and controls products and the biometric verification performed by the user at the vending machine 20, and so forth, and manages and controls various applications used by the user on the user terminal 50. This server 10 is connected to a communication network 4 of the shopping facility 3 via a communication network 2.

The communication network 2 forms an external network of the shopping facility 3, and includes the Internet, a mobile wireless communication network, and the like. The communication network 4 forms an internal network of the shopping facility 3, and includes a wired LAN (Local Area Network), a wireless LAN using WiFi (registered trademark), a short-range wireless network using Bluetooth (registered trademark), and the like.

An access point 5 transmits and receives data as a relay device for a wireless LAN, and has the function of mutually converting a wireless LAN and a wired LAN, a router function for allowing a plurality of user terminals 50 to be connected in a network at the same time, and so forth. The radio wave reception area of the access point 5 is set to a facility area 6 corresponding to the shopping facility 3. Accordingly, the access point 5 performs wireless connection with user terminals 50 that have entered the facility area 6. Consequently, depending on from which access point 5 of a shopping facility 3 the information of a user terminal 50 was acquired, the server 10 can determine in which shopping facility 3 that user terminal 50 is located.

The vending machine 20 is a device that provides products (food, drinking water, clothing, etc.) to users, and is connected so as to allow the exchange of information with the server 10 via the communication network 4 inside the shopping facility and the communication network 2 outside the shopping facility. The vending machine 20 can also use Bluetooth to transmit beacon information to the surrounding area. A device area 7 corresponding to the vending machine 20 is set to the radio wave reception area for beacon information. Therefore, the vending machine 20 performs a short-range wireless connection with any user terminal 50 that has received the beacon information in the device area 7. Consequently, depending on from which access point 5 of a shopping facility 3 the information of a user terminal 50 in a short-range wireless connection with the vending machine 20 was acquired, the server 10 can determine which vending machine 20 installed in which shopping facility 3 that user terminal 50 is approaching.

The user terminal 50 is a smartphone or other such terminal device operated by the user, and is connected through the access point 5 so as to allow the exchange of information with the server 10 via the communication network 2 outside the shopping facility and the communication network 4 inside the shopping facility. The user terminal 50 is also connected to the vending machine 20 via the communication network 4 (short-range wireless network) so as to allow the exchange of information.

Configuration of Server 10

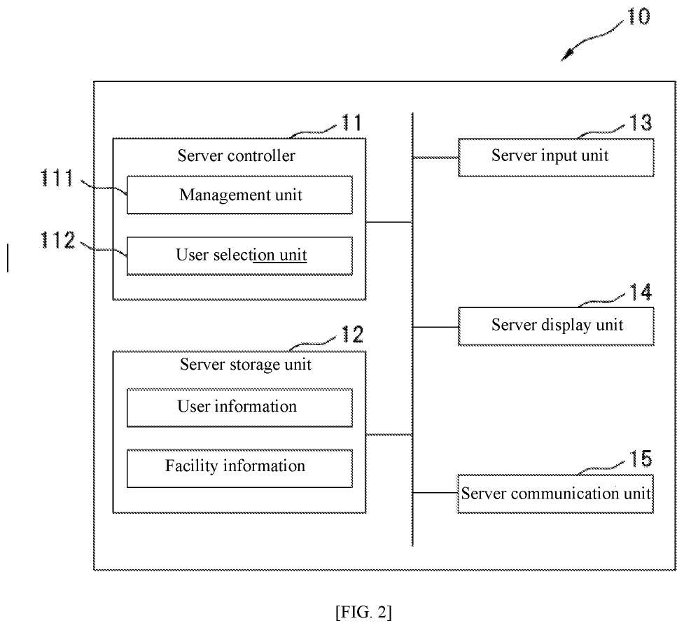

FIG. 2 is a block diagram illustrating the functional configuration of the server 10 according to the first embodiment.

The server 10 is an information processing apparatus used by the system administrator or the like to operate and manage services (for example, a workstation or a personal computer).

As shown in FIG. 2, the server 10 in this embodiment has a server controller 11, a server storage unit 12, a server input unit 13, a server display unit 14, and a server communication unit 15.

The server controller 11 exchanges data between the various units and controls the entire server 10, and consists of a CPU (Central Processing Unit) that executes a program stored in a specific memory. The server controller 11 in this embodiment comprises a management unit 111 and a user selector 112.

The management unit 111 has the function of managing various kinds of information. The management unit 111 in this embodiment manages users who have entered the shopping facility 3, users in the vicinity of the vending machine 20, and so forth, either regularly or at a predetermined time. The management unit 111 in this embodiment also manages the usage status (for example, availability status) of the vending machine 20 in the shopping facility 3 periodically or at a predetermined time.

The user selector 112 has the function of executing processing to select (identify) a portion of the users from among all of the users set in advance. The user selector 112 in this embodiment selects a user located in the shopping facility 3 from among the plurality of users preset in the user information when the user terminal 50 in the possession of a user who has entered the shopping facility 3 is connected with a network so as to allow the exchange of information. The user selector 112 then selects a user in the vicinity of the vending machine 20 from among the users located in an already selected shopping facility 3, when the user terminal 50 in the possession of a user in the vicinity of the vending machine 20 in the shopping facility 3 is connected with a communication network so as to allow the exchange of information.

The server storage unit 12 has ROM (read-only memory), which is a read-only storage area in which a system program is stored, and a RAM (random access memory), which is a rewritable storage area used as a work area for calculation processing by the server controller 11, and consists of a nonvolatile storage device such as a flash memory or a hard disk. The server storage unit 12 in this embodiment stores at least user information, which is information about users, and facility information, which is information about shopping facilities.

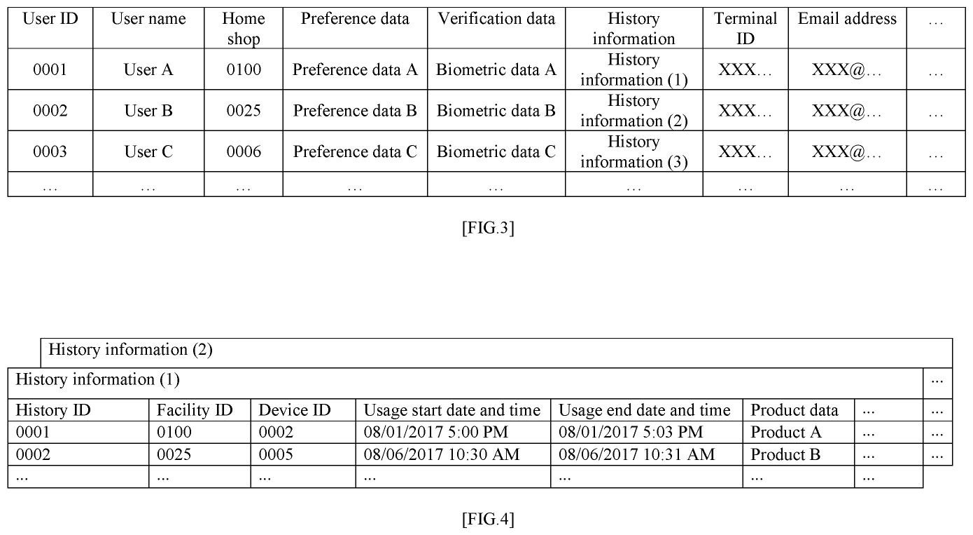

FIG. 3 is a diagram showing an example of the data structure of user information. The categories of this user information include user ID, user name, home shop, preference data, verification data, history information, terminal ID, email address, and so forth. The user ID is identification information for identifying a member user. The user name is information indicating the display name of the member user. The home shop is information indicating the facility serving as a user base. Preference data is information indicating the user's preferences. Verification data is biometric data obtained from the human body (such as image data corresponding to a face, fingerprint, fingertip vein pattern, etc.). History information is information about the user's product purchase history. The terminal ID is identification information for identifying the user terminal 50 in the possession of the user, and is identification information (terminal ID) unique to that terminal, such as a MAC address. The email address is address information used when sending an email to the user. Electronic coupons or the like can also be set as user data in the user information.

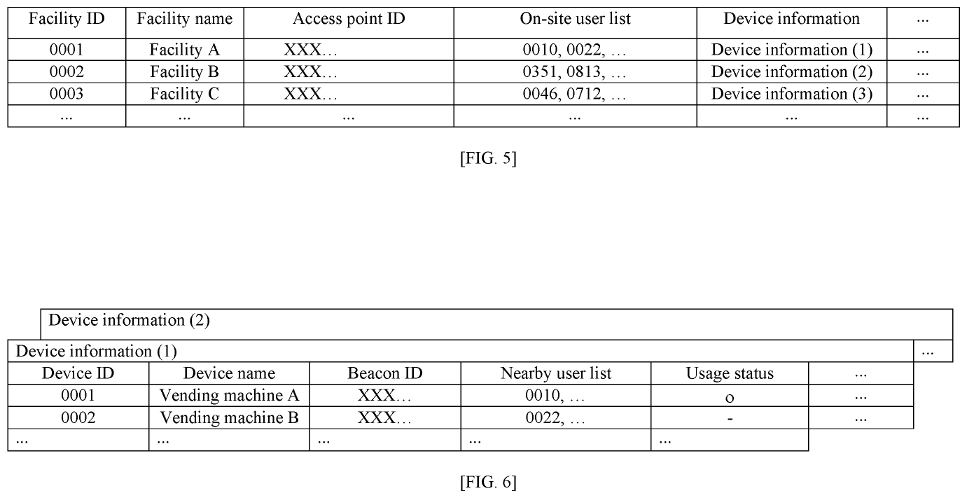

FIG. 4 is a diagram showing an example of the data structure of history information. The categories of this history information include history ID, facility ID, device ID, usage start date and time, usage end date and time, product data, and so forth. The history ID is identification information for identifying the product purchase history. The facility ID is information for identifying the facilities where goods were purchased in the past. The device ID is information for identifying the vending machines 20 where products were purchased in the past. The usage start date and time are information indicating the date and time when the user started using the vending machines. The usage end date and time are information indicating the date and time when the user is done using the vending machined. Product data is data related to products purchased in the past.

FIG. 5 is a diagram showing an example of the data structure of facility information. The categories of this facility information include facility ID, facility name, access point ID, on-site user list, and device information. The facility ID is identification information for identifying the shopping facility 3 from those in the whole country. The facility name is information indicating the display name of the shopping facility 3. The access point ID is identification information for identifying the access point 5 installed in the shopping facility 3, and is identification information that is unique to the terminal (terminal ID), such as a BSSID (basic service set identifier). The on-site user list is a list of users who have entered the shopping facility 3 (hereinafter also referred to as “on-site users”), and includes the terminal ID of the user terminal 50 in the possession of the user. This list is updated regularly or at a predetermined time. The device information is information related to the vending machines 20 installed in the shopping facilities 3.

FIG. 6 is a diagram showing an example of the data structure of device information. The categories of this device information include device ID, device name, beacon ID, nearby user list, and usage status. The device ID is identification information for identifying the vending machines 20 installed in the shopping facilities 3. The device name is information indicating the display name of a vending machine 20. The beacon ID is identification information that identifies a beacon transmitter included in a vending machine 20, and is identification information unique to the equipment (equipment ID), such as a UUID (universally unique identifier). The nearby user list is a list of users in the vicinity of the vending machine 20 (hereinafter also referred to as “nearby users”), and includes a terminal ID of the user terminal 50 in possession of a user. This list is updated regularly or at a predetermined time. The usage status is information indicating whether or not a vending machine 20 is in an available state.

The server input unit 13 is used by a system administrator or the like for inputting various kinds of data, and consists of a keyboard, a mouse, or the like, for example. The server 10 may be configured such that the server input unit 13 is connected and used only when necessary.

The server display unit 14 is used to display a system administrator operation screen based on a command from the server controller 11, and consists of a liquid crystal display (LCD), for example. The server 10 may be configured such that the server display unit 14 is connected and used only when necessary.

The server communication unit 15 is used for communication between the user terminal 50 and a vending machine 20 installed in a shopping facility 3, and functions as a receiver that receives various kinds of data and signals transmitted from the vending machine 20 and the user terminal 50, and also functions as a transmitter that transmits various kinds of data and signals to the vending machine 20 and the user terminal 50 in accordance with instructions from the server controller 11.

Configuration of Vending Machine 20

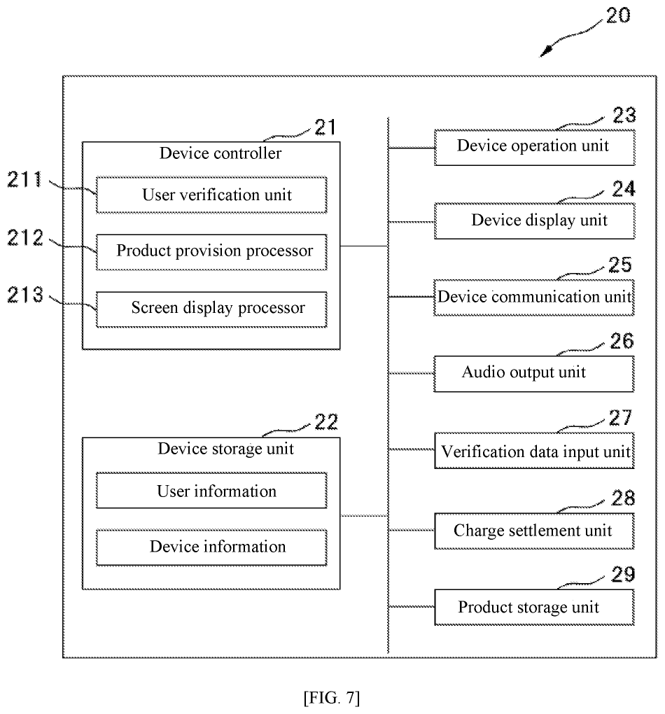

FIG. 7 is a block diagram showing the functional configuration of the vending machine 20 according to the first embodiment.

The vending machine 20 according to this embodiment is a device that is installed in the shopping facility 3 and provides products in response to a payment put in by a user. The vending machine 20 performs biometric verification using biometric data obtained from a human body prior to the purchase of a product.

As shown in FIG. 7, the vending machine 20 in this embodiment has a device controller 21, a device storage unit 22, a device operation unit 23, a device display unit 24, a device communication unit 25, an audio output unit 26, a verification data input unit 27, a charge settlement unit 28, and a product storage unit 29.

The device controller 21 performs control over the entire vending machine 20, and consists of a CPU (Central Processing Unit) that executes a program stored in a specific memory.

The device controller 21 in this embodiment has a user verification unit 211, a product provision processor 212, a screen display processor 213, and so on. The user verification unit 211 has the function of executing user verification processing. The user verification unit 211 in this embodiment performs user verification using biometric data obtained from a human body. The product provision processor 212 has the function of executing product provision processing for providing a product to the user. The screen display processor 213 has the function of executing screen display processing, such as a guidance screen, an advertisement screen, or an operation screen.

The device storage unit 22 has a ROM (Read-Only Memory), which is a read-only storage area in which are stored various programs and various kinds of information necessary for the vending machine 20, and a RAM (Random Access Memory), which is a rewritable storage area that is used as a work area for calculation processing performed by the device controller 21, and consists of a nonvolatile storage device such as a flash memory or a hard disk.

The device storage unit 22 in this embodiment stores device information (the device ID of the vending machine 20, the beacon ID of a beacon transmitter included the vending machine 20, etc.), user information (user ID, the terminal ID of the user terminal 50, biometric data, preference data, etc.), and the like. User information (biological data and the like) for nearby users can be prepared in advance, prior to the performance of biometric verification.

The device operation unit 23 allows a user or the like to perform various operations, and consists of operation buttons or the like provided on an operation panel, for example. In this embodiment, the device operation unit 23 is used when the user selects the type of product and purchases the product.

The device display unit 24 displays a guidance screen related to product purchase, a product advertisement screen, or the like based on instructions from the device controller 21, or displays an operation screen in accordance with the progress of biometric verification, and consists of a liquid crystal display (LCD) or the like, for example.

The device communication unit 25 is used for communicating with the server 10, and functions as a receiver that receives various kinds of data and signals transmitted from the server 10, and also functions as a transmitter that transmits various kinds of data and signals to the server 10 in accordance with instructions from the device controller 21. Also, the device communication unit 25 is used for performing short-range wireless communication with the user terminal 50, and functions as a receiver that receives various kinds of data and signals transmitted from the user terminal 50, and also functions as a transmitter that transmits various kinds of data and signals to the user terminal 50 in accordance with instructions from the device controller 21.

The device communication unit 25 in this embodiment has a beacon transmitter that uses short-range wireless communication at low power consumption based on BLE (Bluetooth Low Energy) to transmit beacon information including a beacon ID. Since the device area 7 corresponding to the vending machine 20 is set as the radio wave reception area, the beacon transmitter repeatedly transmits beacon information at regular intervals so as to cover this device area 7. A user terminal 50 that enters this device area 7 can receive the beacon information and establish a short-range wireless connection without any pairing being performed.

The audio output unit 26 amplifies the audio signal (audio information), such as a voice or a sound effect, outputted from the device controller 21 with a digital amplifier or the like, and outputs the sound. For example, it consists of a speaker or the like.

The verification data input unit 27 acquires user biometric data for user verification. In this embodiment, as an example of verification data, biometric data obtained from a human body (such as the face, a fingerprint, or the fingertip vein pattern) is acquired from the user. The verification data input unit 27 in this embodiment has a sensor that reads the user's face, fingerprint, finger vein pattern, or the like as an image. The user input includes not only the user's conscious input, but also unconscious input. For instance, when facial recognition is performed, the user may input data by consciously bringing his or her face close to the reading range of the sensor, or a vending machine is installed so that the position of a user's face is included in the reading range of the reading sensor and data is entered when the user stands directly in front of the vending machine (without being aware of the sensor).

The charge settlement unit 28 executes settlement processing of the charge for the product. The charge settlement unit 28 requests the device controller 21 to start execution of the product provision processing once payment is completed when the user pays for the product by inserting coins or using the electronic money function of an IC card.

The product storage unit 29 stores products that will be provided to users inside the vending machine 20. In this embodiment, a plurality of types of product can be stored in the vending machine 20.

Configuration of User Terminal 50

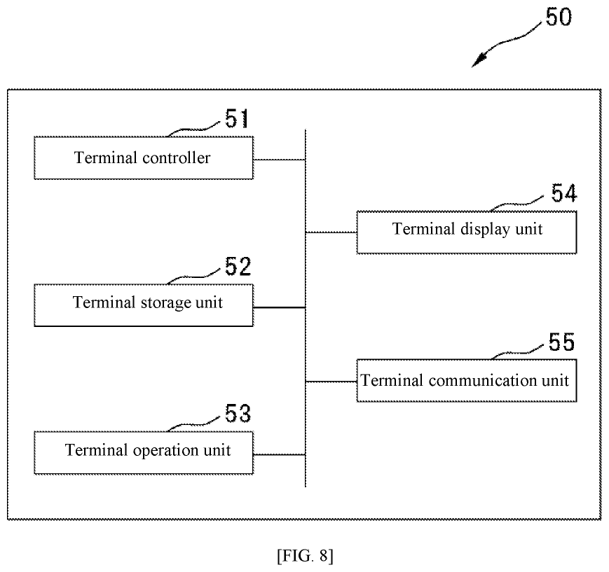

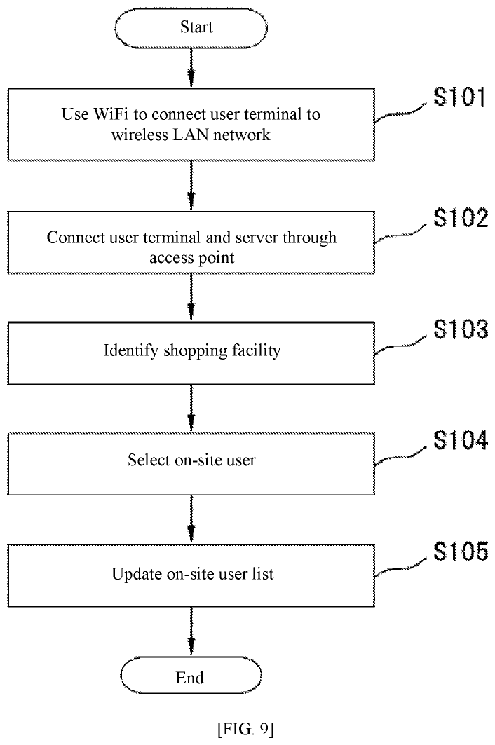

FIG. 8 is a block diagram of the functional configuration of the user terminal 50 according to the first embodiment. The user terminal 50 according to this embodiment is an information processing device that can be carried and used by a user (such as a smartphone, a tablet terminal, or a mobile phone terminal).

As shown in FIG. 8, the user terminal 50 in this embodiment has a terminal controller 51, a terminal storage unit 52, a terminal operation unit 53, a terminal display unit 54, and a terminal communication unit 55.

The terminal controller 51 performs control over the entire user terminal 50, and consists of a CPU that executes a specific program stored in a memory. The terminal controller 51 in this embodiment has the function of executing various applications related to user verification, the function of executing screen display processing, such as for operation screens, application screens, and browser screens, and other such functions.

The terminal storage unit 52 has a ROM, which is a read-only storage area in which are stored various applications and various kinds of information necessary for the user terminal 50, and a RAM, which is a rewritable storage area that is used as a work area for calculation processing performed by the terminal controller 51. The terminal storage unit 52 in this embodiment stores user email addresses, the terminal ID of the user terminal 50, and the like.

The terminal operation unit 53 is used for accepting operations from the user who is operating the user terminal 50. The terminal operation unit 53 in this embodiment is equipped with a touch panel, and can accept operations specific to a touch panel, such as a tap, swipe, or flick, from the user.

The terminal display unit 54 is used to display operation screens in accordance with the progress of various applications based on instructions from the terminal controller 51, and to display Web pages written in a language such as HTML (Hyper Text Markup Language) by a browser function, and consists of a liquid crystal display or the like, for example.

The terminal communication unit 55 is used for communicating with the server 10, and functions as a receiver that receives various kinds of data and signals transmitted from the server 10 and also functions as a transmitter that transmits various kinds of data and signals to the server 10 in accordance with instructions from the terminal controller 51. The terminal communication unit 55 is also used for performing short-range wireless communication with the vending machine 20, and functions as a receiver that receives various kinds of data and signals transmitted from the vending machine 20, and also functions as a transmitter that transmits various kinds of data and signals to the vending machine 20 in accordance with instructions from the terminal controller 51.

The terminal communication unit 55 in this embodiment can establish a short-range wireless connection and receive beacon information transmitted from the beacon transmitter included in the vending machine 20 by means of short-range wireless communication using BLE.

In addition, the user terminal 50 encompasses a configuration in which the terminal operation unit 53, the terminal display unit 54, and so forth are omitted, and the only functions are those necessary for entry into the shopping facility 3 and user verification by the vending machine 20 in that facility (for example, a facility-dedicated terminal that is on loan at a shopping facility).

Operation of Verification System 1

An example of how the verification system 1 according to the first embodiment operates will be described. With this verification system 1, when a user in possession of a user terminal 50 enters a shopping facility 3, that user terminal 50 is connected to the network via the access point 5 and is selected by the server 10 as an on-site user who is located in the facility from among all the member users.

After this, when an on-site user approaches the vending machine 20 in the facility, the user terminal 50 in possession of this on-site user establishes a short-range wireless connection with that vending machine 20, after which it is connected to the network via the access point 5 and is selected by the server 10 as a nearby user from among all the on-site users.

Then, before actually performing user verification at the vending machine 20 which the nearby user has approached, the server 10 transmits biometric data about the nearby user to the vending machine 20.

In this way, after the users who are most likely to use the vending machine 20 in the facility have been narrowed down in steps, a user who will actually undergo user verification at the vending machine 20 in that facility can be identified. Therefore, the user can be identified faster than when searching among all the member users, so user verification can be completed faster. As a result, it is possible to shorten the waiting time until the user actually receives the service provided by the vending machine 20 in the facility after the user verification.

Furthermore, because biometric data about the nearby user is acquired ahead of time by the vending machine 20 in the facility, it is not necessary to access the server 10 and acquire the biometric data when it is time to actually perform user verification. Therefore, user verification can be completed faster. As a result, it is possible to further shorten the waiting time until the user actually receives the service provided by the vending machine 20 in the facility after user verification.

Selection of a User in the Vicinity of the Vending Machine 20 in the Facility

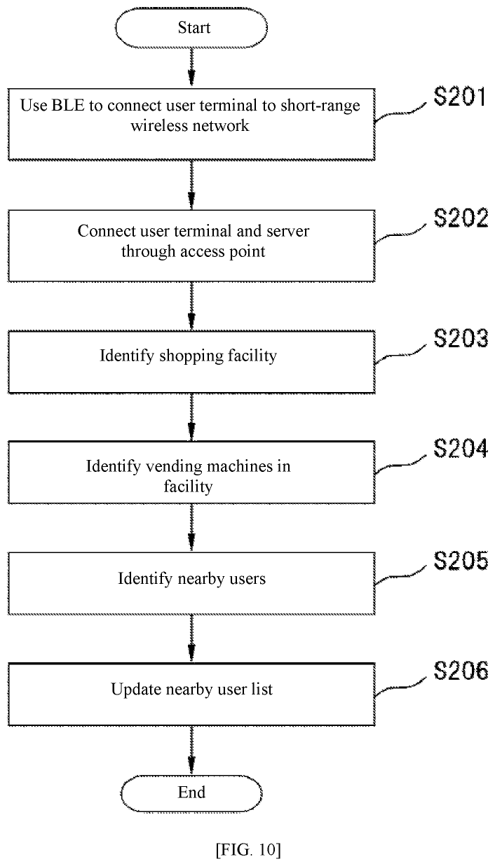

FIG. 10 is a flowchart illustrating the processing related to selection of a user who is in the vicinity of the vending machine 20 in the facility.

When an on-site user in possession of the user terminal 50 moves to the device area 7 corresponding to the vending machine 20 in the shopping facility 3, the user terminal 50 of that on-site user receives beacon information transmitted from the beacon transmitter included in the vending machine 20 by short-range wireless communication using BLE. When the user terminal 50 of the on-site user then receives the beacon information transmitted from the beacon transmitter included in the vending machine 20, it is connected to the communication network 4 (short-range wireless network) according to a facility application (step S201).

Next, the user terminal 50 relays the beacon ID (equipment ID), terminal ID (identification data about the user's own user terminal), access point ID of the access point 5, and so forth included in the received beacon information through the access point 5 in the facility and transmits this data to the server 10 via the communication network 4 (wireless LAN network or wired LAN network) and the communication network 2 (step S202).

Next, the server 10 uses the information received from the user terminal 50 via the communication network to identify the shopping facility 3 where the user terminal 50 is located, from among the nationwide shopping facilities included in the facility information stored in the server storage unit 12 (step S203).

More specifically, the user selector 112 of the server 10 refers to the facility information shown in FIG. 5 to identify the shopping facility associated with the access point ID (terminal ID) received from that user terminal 50.

Next, the server 10 uses the information received from the user terminal 50 via the communication network to identify the vending machine 20 approached by the user terminal 50 from among all the vending machines in the facility included in the device information stored in the server storage unit 12 (step S204).

More specifically, the user selector 112 of the server 10 acquires device information associated with the shopping facility 3 specified by the processing of step S203 described above from the facility information shown in FIG. 5. The user selector 112 of the server 10 then specifies the vending machine 20 in the facility associated with the beacon ID received from the user terminal 50 by referring to the device information shown in FIG. 6.

Next, the server 10 uses the information received from the user terminal 50 via the communication network to select a user who is in the vicinity of a vending machine in the specified shopping facility as a nearby user from the on-site user list included in the facility information stored in the server storage unit 12 (step S205).

More specifically, the user selector 112 of the server 10 acquires an on-site user list associated with the shopping facility 3 specified by the processing of step S203 described above from the facility information shown in FIG. 5. The user selector 112 of the server 10 then selects a user associated with the terminal ID received from that user terminal 50 from all the on-site users included in the acquired on-site user list.

Thus, searching through a previously narrowed down list of on-site users is more efficient than searching through all the member users because nearby users can be identified faster.

Next, when a nearby user is selected from among all the on-site users in this way, the server 10 updates the nearby user list for the specified vending machine included in the device information stored in the server storage unit 12 (step S206).

More specifically, the management unit 111 of the server 10 acquires the nearby user list of the vending machine specified by the above-mentioned processing of step S204 from the device information shown in FIG. 6, and adds the user selected by the above-mentioned processing of step S205 to the list as a nearby user of that vending machine.

As described above, with the verification system 1 in this embodiment, one or more user terminals 50 located in radio wave reception areas respectively corresponding to vending machines in various shopping facilities are scanned regularly or at a predetermined time using short-range wireless communication by BLE, which allows any users who are in the vicinity of a vending machine in each shopping facility at the current time to be selected from among all the on-site users included in the facility information stored in the server storage unit 12, and added to the list.

User Verification

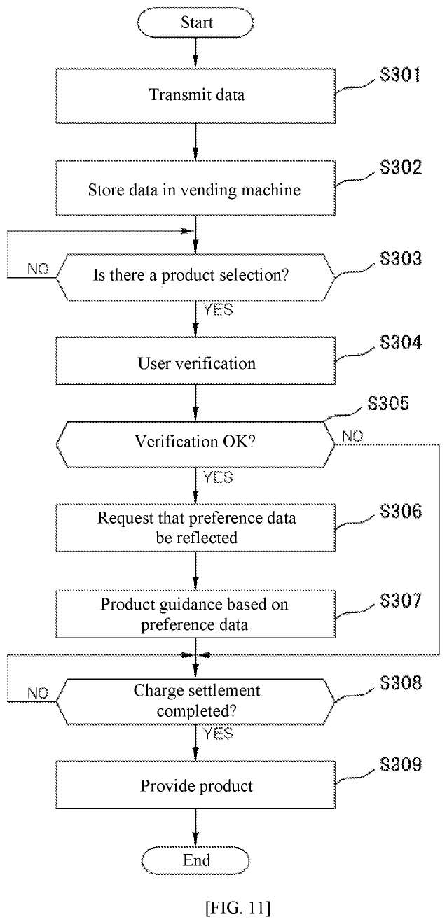

FIG. 11 is a flowchart illustrating the processing related to user verification.

When the nearby user list included in the device information shown in FIG. 6 is updated, the server communication unit 15 of the server 10 acquires biometric data, preference data, and so forth about the nearby users included in this nearby user list from the user information shown in FIG. 3. The server communication unit 15 of the server 10 then transmits the acquired data to the vending machine 20 approached by the user included in the nearby user list (step S301).

Next, upon receiving the data transmitted from the server 10, the device communication unit 25 of the vending machine 20 requests that the device controller 21 of the vending machine 20 store the received data in the device storage unit 22. Upon receiving the request from the device communication unit 25, the device controller 21 of the vending machine 20 causes the device storage unit 22 to store biometric data, preference data, and so forth about the nearby users transmitted from the server 10 (step S302).

Consequently, biometric data, preference data, and so forth about nearby users included in the nearby user list at the current time are prepared in the vending machine 20 in the shopping facility.

Next, the product provision processor 212 of the vending machine 20 determines whether or not any of the nearby users has operated the device operation unit 23 to select a product from among a plurality of types of product (step S303).

If the result of this determination is that none of the nearby users has selected any of the products yet (No in step S303), the system waits until that selection operation is performed. On the other hand, if it is determined that any of the nearby users has selected any of the products (Yes in step S303), the processing proceeds to the next step S304.

Next, the product provision processor unit 212 of the vending machine 20 requests that the user verification unit 211 of the vending machine 20 execute user verification processing if any of the nearby users has selected a product. Upon receiving a request from the product provision processor 212, the user verification unit 211 of the vending machine 20 performs user verification for the nearby user who has selected that product before the product is provided (step S304).

More specifically, when the verification data input unit 27 of the vending machine 20 acquires biometric data inputted by the nearby user, the user verification unit 211 of the vending machine 20 receives that biometric data. The user verification unit 211 of the vending machine 20 then compares the biometric data for the nearby user acquired by the verification data input unit 27 with the biometric data in the nearby user list prepared in advance in the device storage unit 22 by the processing of step S302 described above, and thereby performs biometric verification. Thus, there is no need to access the server 10 and acquire biometric data for the nearby user during user verification, so user verification can be completed faster, so it is possible to shorten the waiting time until the product can be provided.

Next, the user verification unit 211 of the vending machine 20 determines whether or not the user verification was successful (step S305). If the user verification failed (No in step S305), the processing proceeds to step S308 discussed below. On the other hand, if the user verification was successful (Yes in step S305), the processing proceeds to the next step S306.

Next, the user verification unit 211 of the vending machine 20 requests that the product provision processor 212 of the vending machine 20 causes the preference data for the nearby user who has been correctly verified to be reflected in the product description if the user verification was successful (step S306).

Next, upon receiving this request from the user verification unit 211, the product provision processor 212 of the vending machine 20 acquires preference data for the nearby user who has been correctly verified from the nearby user list that has been prepared in advance in the device storage unit 22, and gives a product description based on this acquired preference data (step S307).

That is, the product provision processor 212 of the vending machine 20 causes the device display unit 24 to display a product description screen that matches the preference of the verified nearby user, or causes the audio output unit 26 to output product description audio that matches the preference of the verified nearby user. Here again, there is no need to access the server 10 and acquire preference data for a correctly authenticated nearby user after user verification is completed, so it is possible to shorten the waiting time until the service can be provided.

Next, the charge settlement unit 28 of the vending machine 20 determines whether or not the settlement has been completed by the nearby user by paying the price of the product selected by the user by inserting coins or using the electronic money function of an IC card (step S308).

If the result of this determination is that the price of the product has not been paid and the settlement has not been completed (No in step S308), the system waits until the settlement is completed. On the other hand, if it is determined that the price of the product has been paid and settlement has been completed (Yes in step S308), the charge settlement unit 28 of the vending machine 20 requests that the product provision processor 212 of the vending machine 20 start executing product provision.

Next, upon receiving this request from the charge settlement unit 28, the product provision processor 212 of the vending machine 20 controls the product storage unit 29 so as to provide the product selected by the nearby user from among the plurality of types of products that have been stored in advance (step S309).

As described above, with the verification system 1 according to the first embodiment, narrowing down to the nearby users who are most likely to use the vending machine 20 in the shopping facility allows the nearby user who will actually undergo user verification at that vending machine 20 to be identified more quickly. Accordingly, user verification can be completed faster, so it is possible to shorten the waiting time until the service is actually provided at the vending machine 20 in the shopping facility. Furthermore, because the biometric data about nearby users and so forth are prepared in advance in the vending machine 20, there is no need to access the server 10 when actually performing user verification of nearby users. Therefore, user verification can be completed faster, so it is possible to further shorten the waiting time until the service is actually received.

### Second Embodiment

In the second embodiment, a verification system for performing biometric verification with a POS terminal will be specifically described as an example, using a verification device in a shopping facility as an example of a usage facility.

Configuration of Verification System 1

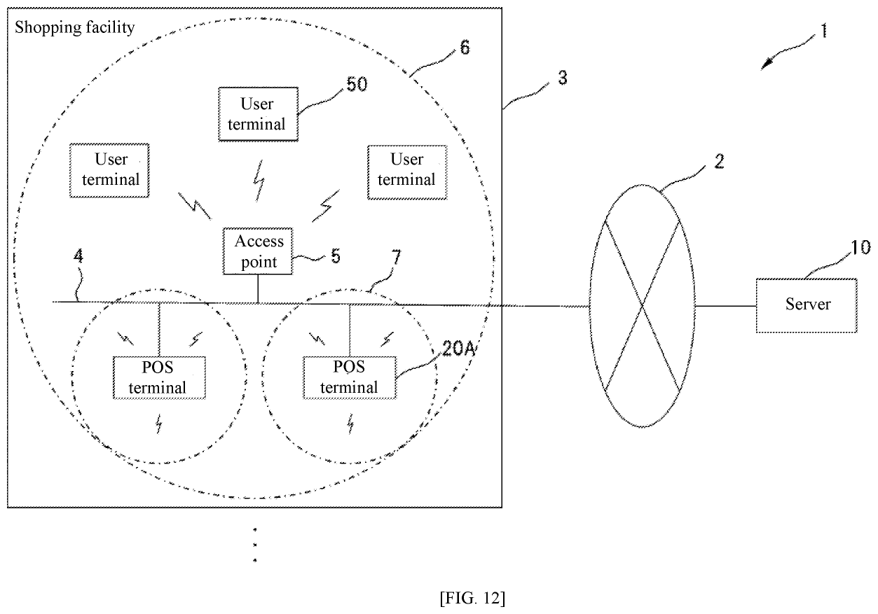

FIG. 12 is a network configuration diagram illustrating an example of the verification system 1 according to the second embodiment.

In the verification system 1 according to the second embodiment, when a user who has entered a shopping facility 3 undergoes biometric verification at a POS (Point Of Sale) terminal in that facility and then pays the fee at that POS terminal, discounts can be given with electronic coupons.

With the verification system 1 according to the second embodiment, the server 10, one or more POS terminals 20A installed in one or more shopping facilities 3, and the user terminal(s) 50 in the possession of one or more users who have entered these shopping facilities 3 are connected via a network so as to allow the exchange of information.

Thus, the verification system 1 according to the second embodiment differs from the verification system 1 according to the first embodiment described above in that biometric verification is performed not at the vending machine 20, but at the POS terminal 20A. Also, the server 10 and the user terminal 50 according to the second embodiment have the same configuration as in the verification system 1 according to the first embodiment described above.

The POS terminal 20A is a device that is used when a user pays for a product, and is connected to the server 10 so as to allow the exchange of information via the communication network 4 in the shopping facility and the communication network 2 outside the shopping facility. Also, the POS terminal 20A can use Bluetooth to transmit beacon information to the surrounding area. The device area 7 corresponding to the POS terminal 20A is set as a radio wave reception area for beacon information. Therefore, the POS terminal 20A establishes a short-range wireless connection with any user terminal 50 that has received the beacon information in the device area 7. Consequently, depending on from which access point 5 of the shopping facility 3 the user terminal 50 connected by short-range wireless connection to the POS terminal 20A was acquired, the server 10 can determine which POS terminal 20A installed in which shopping facility 3 is approached by that user terminal 50. The configuration of the POS terminal 20A will now be described.

Configuration of POS Terminal 20A

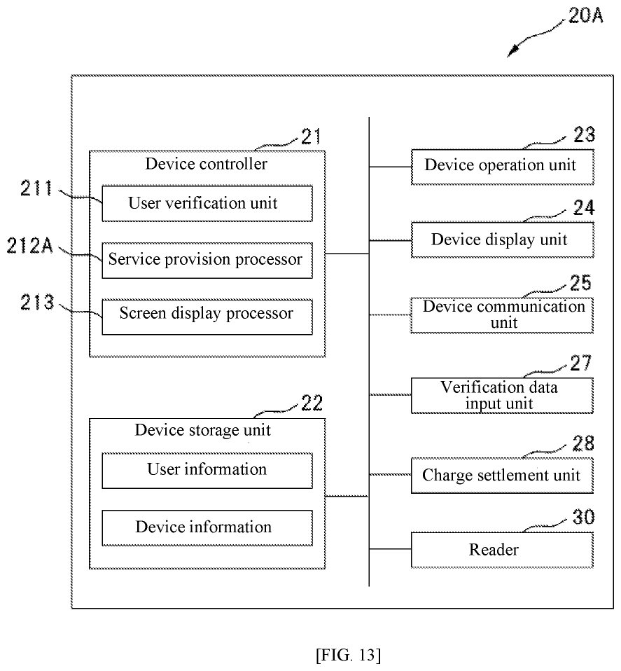

FIG. 13 is a block diagram of the functional configuration of the POS terminal 20A according to the second embodiment.

The POS terminal 20A according to the second embodiment is a device that is installed in the shopping facility 3 and performs settlement by payment from a user. This POS terminal 20A performs biometric verification by using biometric data obtained from a human body prior to settlement.

As shown in FIG. 13, the POS terminal 20A in the second embodiment has the device controller 21, the device storage unit 22, the device operation unit 23, the device display unit 24, the device communication unit 25, the verification data input unit 27, the charge settlement unit 28, and a reader 30.

The device controller 21 has the user verification unit 211, a service provision processor 212A, the screen display processor 213, and so forth. The service provision processor 212A has the function of executing service provision processing in order to provide a service to users.

The reader 30 reads the barcode attached to the service to be provided (the product) with a barcode reader, extracts a code (such as the price of the product), and delivers this to the charge settlement unit 28. Since the other functional units have the same configuration as those in the verification system 1 according to the first embodiment, they will not be described again.

Operation of Verification System 1

An operation example of the verification system 1 according to the second embodiment will be described. With the verification system 1 according to the second embodiment, just as with the verification system 1 according to the first embodiment, when a user in possession of the user terminal 50 enters the shopping facility 3, that user terminal 50 is connected to a network through the access point 5, and as a result the server 10 selects that user as an on-site user who is located in the facility from all the member users.

After that, when an on-site user approaches the POS terminal 20A in the facility, the user terminal 50 in possession of that on-site user is connected to the POS terminal 20A by wireless short-range connection, after which it is connected to a network via the access point 5, and thereby selected by the server 10 as a nearby user from among all the on-site users.

Then, before the nearby user actually undergoes user verification at the POS terminal 20A approached by that user, the server 10 transmits biometric data about the nearby user to the POS terminal 20A.

In this way, the user who will actually undergo user verification at the POS terminal 20A in the facility can be identified after users who are most likely to use the POS terminal 20A in the facility have been narrowed down in steps. Therefore, user verification can be completed faster as the user can be identified faster than when searching among all the member users. As a result, it is possible to shorten the waiting time until the user actually receives the service and completes payment at the POS terminal 20A in the facility after the user verification.

Furthermore, because the POS terminal 20A in the facility is made to acquire biometric data about nearby users in advance, there is no need to access the server 10 and acquire biometric data when user verification is to be actually performed. Therefore, user verification can be completed faster. As a result, it is possible to further shorten the waiting time until the user actually receives the service and completes payment at the POS terminal 20A in the facility after the user verification.

In the verification system 1 according to the second embodiment, the processing related to the selection of users who have entered the shopping facility 3 and the processing related to the selection of users who approach to the POS terminal 20A in the facility are executed in the same manner as with the verification system 1 according to the first embodiment. The processing related to user verification will now be described in specific terms below.

User Verification

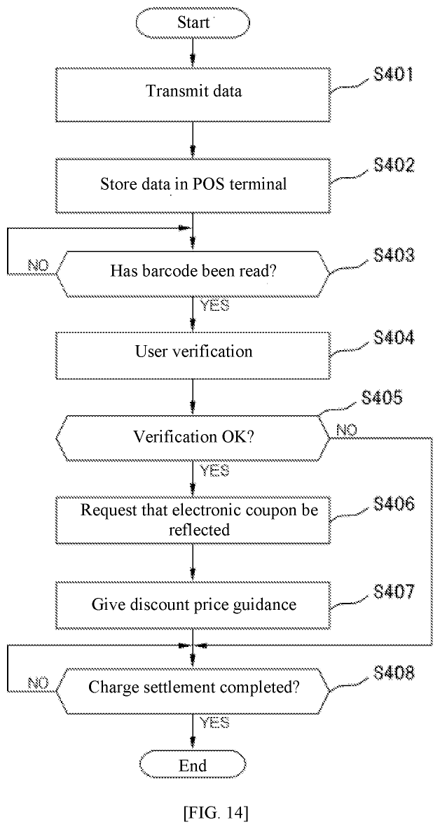

FIG. 14 is a flowchart illustrating the processing related to user verification.

When the nearby user list included in the device information shown in FIG. 6 is updated, the server communication unit 15 of the server 10 acquires nearby user biometric data included in the nearby user list, electronic coupons, and so forth from the user information shown in FIG. 3. The server communication unit 15 of the server 10 then transmits the acquired data to the POS terminals 20A approached by the users in the nearby user list (step S401).

Next, upon receipt of the data transmitted from the server 10, the device communication unit 25 of the POS terminal 20A requests the device controller 21 of the POS terminal 20A to store the received data in the device storage unit 22. Upon receiving the request from the device communication unit 25, the device controller 21 of the POS terminal 20A causes the device storage unit 22 to store nearby user biometric data, electronic coupons, and the like transmitted from the server 10 (step S402).

Consequently, the biometric data, electronic coupons, and so forth of nearby users included in the nearby user list at the current time are prepared in the POS terminal 20A in the shopping facility.

Next, the service provision processor 212A of the POS terminal 20A determines whether or not the reader 30 has read the barcode of a product that any of the nearby users wants to purchase (step S403).

If the result of this determination is that that the reader 30 has not read the barcode of a product that any nearby user wants to purchase (No in step S403), the system waits until that selection operation is performed. On the other hand, if it is determined that the reader 30 has read the barcode of a product that any of the nearby users wants to purchase (Yes in step S403), the processing proceeds to the next step S404.

Next, if the reader 30 has read the barcode of a product that any of the nearby users wants to purchase, the service provision processor 212A of the POS terminal 20A requests the user verification unit 211 of the POS terminal 20A to execute user verification processing. Upon receiving this request from the service provision processor 212A, the user verification unit 211 of the POS terminal 20A performs user verification for the nearby user who selected that product prior to settlement (step S404).

More specifically, when the verification data input unit 27 of the POS terminal 20A acquires the biometric data inputted by a nearby user, the user verification unit 211 of the POS terminal 20A receives that biometric data. The user verification unit 211 of the POS terminal 20A then performs biometric verification by comparing and contrasting the biometric data of the nearby user acquired by the verification data input unit 27 with the biometric data in the nearby user list prepared in advance in the device storage unit 22 by the processing of step S402 described above. Thus, there is no need to access the server 10 and acquire the biometric data of the nearby user at the time of user verification, so the user verification can be completed faster, and it is possible to shorten the waiting time until the service is provided.

Next, the user verification unit 211 of the POS terminal 20A determines whether or not the user verification was successful (step S405), and if the user verification failed (No in step S405), the processing proceeds to S408 (discussed below). On the other hand, if the user verification was successful (Yes in step S405), the processing proceeds to the next step S406.

Next, if the user verification was successful, the user verification unit 211 of the POS terminal 20A requests that service provision processor 212A of the POS terminal 20A causes the product price to be reflected in the electronic coupon of the nearby user who has been correctly verified (step S406).

Next, upon receiving this request from the user verification unit 211, the service provision processor 212A of the POS terminal 20A acquires the electronic coupon of the nearby user who was correctly verified from the nearby user list prepared in advance in the device storage unit 22, and gives discount price guidance based on the acquired electronic coupon (step S407).

That is, the service provision processor 212A of the POS terminal 20A causes the device display unit 24 to display the product price that has been discounted by a certain amount in accordance with the electronic coupon of the verified nearby user. Here again, since there is no need to access the server 10 and acquire the electronic coupon of the correctly verified nearby user after the user verification is completed, it is possible to shorten the waiting time until the service can be provided.

Next, the charge settlement unit 28 of the POS terminal 20A determines whether or not the settlement has been completed by paying for the product selected by the nearby user, either by putting in coins or by using the electronic money function of an IC card (step S408).

If the result of this determination is that the product has not been paid for and the settlement has not been completed (No in step S408), the system waits until the settlement is completed. On the other hand, if it is determined that the product has been paid for and the settlement is completed (Yes in step S408), this processing is ended, and a clerk in the shopping facility 3 hands that product to the user.

As described above, with the verification system 1 according to the second embodiment, narrowing down to the nearby users who are most likely to use the POS terminal 20A in the shopping facility allows the nearby user who will actually undergo user verification at that POS terminal 20A to be identified more quickly. Accordingly, user verification can be completed faster, so it is possible to shorten the waiting time until the service is actually provided at the POS terminal 20A in the shopping facility. Furthermore, because the biometric data about nearby users and so forth are prepared in advance in the POS terminal 20A, there is no need to access the server 10 when actually performing user verification of nearby users. Therefore, user verification can be completed faster, so it is possible to further shorten the waiting time until the service is actually received.

### Third Embodiment

In the third embodiment, a verification system for performing biometric verification with a check-in device will be described as an example of a verification device in a medical facility as an example of a usage facility.

Configuration of Verification System 1

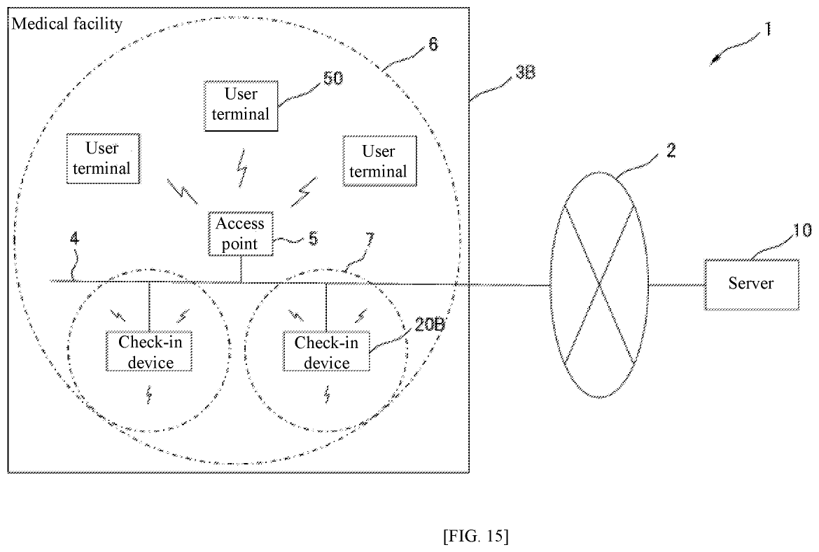

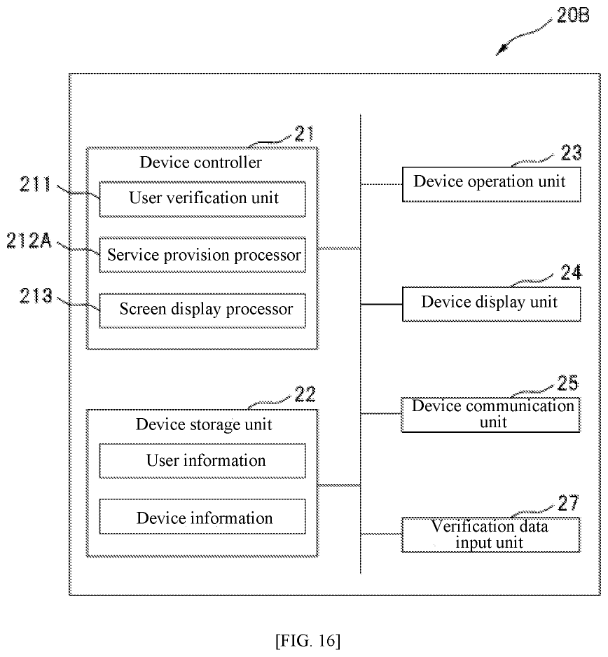

FIG. 15 is a network configuration diagram showing an example of the verification system 1 according to the third embodiment.

In the verification system 1 according to the third embodiment, a user who has entered a medical facility undergoes biometric verification at a check-in device in that facility, after which medical treatment check-in is performed with this check-in device, and medical service is provided according to the electronic medical record.

With the verification system 1 according to the third embodiment, the server 10, one or more check-in devices 20B installed in one or more medical facilities 3B, and a user terminal 50 in the possession of one or more users who have entered these medical facilities 3B are connected so as to allow the exchange of information via a network.

Thus, the verification system 1 according to the third embodiment differs from the verification system 1 according to the first embodiment described above in that biometric verification is performed not by a vending machine 20 in a shopping facility 3, but by the check-in device 20B of the medical facility 3B. Also, the server 10 and the user terminal 50 according to the third embodiment have the same configuration as the verification system 1 according to the first embodiment described above. However, at least the electronic medical records of various users are included in the user information stored in the server storage unit 12.

The check-in device 20B is a device that is used for checking in a user for medical treatment, and is connected to the server 10 via a communication network 4 inside the medical facility and a communication network 2 outside the medical facility so as to allow the exchange of information. Also, the check-in device 20B can use Bluetooth to transmit beacon information to the surrounding area. The device area 7 corresponding to the check-in device 20B is set as a radio wave reception area for beacon information. Therefore, the check-in device 20B establishes a short-range wireless connection with the user terminal 50 that has received the beacon information in the device area 7. Consequently, depending on from which access point 5 of the medical facility 3B the information about the user terminal 50 in short-range wireless connection with the check-in device 20B has been acquired, the server 10 can determine which check-in device 20B installed in which medical facility 3B is approached by that user terminal 50. The configuration of the check-in device 20B will now be described.

Configuration of Check-In Device 20B

FIG. 16 is a block diagram of the functional configuration of the check-in device 20B according to the third embodiment.

The check-in device 20B according to the third embodiment is installed in a medical facility 3B, and is a device at which a user checks in to receive medical treatment. This check-in device 20B performs biometric verification by using biometric data obtained from the human body before medical treatment is given.

As shown in FIG. 16, the check-in device 20B in the third embodiment has the device controller 21, the device storage unit 22, the device operation unit 23, the device display unit 24, the device communication unit 25, and the verification data input unit 27.

The device controller 21 has the user verification unit 211, the service provision processor 212A, the screen display processor 213, and so on. The service provision processor 212A has the function of executing service provision processing in order to provide medical service to the user.

Operation of Verification System 1

An operation example of the verification system 1 according to the third embodiment will be described. With the verification system 1 according to the third embodiment, just as with the verification system 1 according to the first embodiment, when a user in possession of a user terminal 50 enters a medical facility 3B, that user terminal 50 is connected to the network through the access point 5, and as a result the server 10 selects that user as an on-site user who is located in the facility from among all the member users.

After that, when an on-site user approaches a check-in device 20B in the facility, the user terminal 50 in possession of that on-site user establishes a short-range wireless connection with that check-in device 20B, after which it is connected to the network via the access point 5, and is thereby selected by the server 10 as a nearby user from among all the on-site users.

Then, before that nearby user is actually undergoes user verification at the check-in device 20B approached by that nearby user, the server 10 transmits biometric data about that nearby user to this check-in device 20B.

In this way, the user who will actually undergo user verification at the check-in devices 20B in the facility can be identified after users who are most likely to use the check-in devices 20B in the facility have been narrowed down in steps. Therefore, user verification can be completed faster as the user can be identified faster than when searching among all the member users. As a result, it is possible to shorten the waiting time until the user is actually provided with medical service with the check-in device 20B in the facility after the user verification.

Furthermore, because the check-in devices 20B in the facilities is made to acquire biometric data about nearby users in advance, there is no need to access the server 10 and acquire biometric data when user verification is actually performed. Therefore, user verification can be completed faster. As a result, it is possible to further shorten the waiting time until the user actually receives medical service at the check-in device 20B in the facility after the user verification.

In the verification system 1 according to the third embodiment, processing related to the selection of users who have entered a medical facility 3B, and processing related to the selection of users who approach a check-in device 20B in the facility are executed in the same manner as with the verification system 1 according to the first embodiment. The processing related to user verification will now be described in specific terms.

User Verification

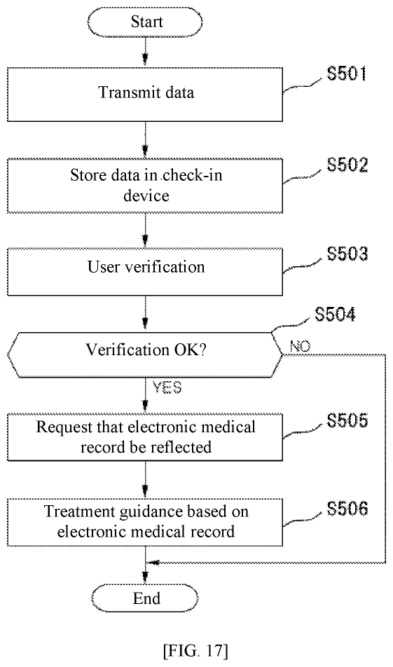

FIG. 17 is a flowchart illustrating the processing related to user verification.

When the nearby user list included in the device information shown in FIG. 6 is updated, the server communication unit 15 of the server 10 acquires biometric data, electronic medical records, and so forth for nearby users included in the nearby user list from the user information shown in FIG. 3. The server communication unit 15 of the server 10 then transmits the acquired data to the check-in device 20B approached by a user in the nearby user list (step S501).

Next, upon receipt of the data transmitted from the server 10, the device communication unit 25 of the receiving device 20B requests the device controller 21 of the check-in device 20B to store the received data in the device storage unit 22. Upon receiving the request from the device communication unit 25, the device controller 21 of the check-in device 20B causes the device storage unit 22 to store the nearby user biometric data, electronic medical record, and the like transmitted from the server 10 (step S502).

Consequently, the biometric data, electronic medical record, and so forth of nearby users included in the nearby user list at the current time are prepared in the check-in device 20B in the medical facility.

Next, the user verification unit 211 of the check-in device 20B performs user verification for any of the nearby users who has come to the check-in desk (step S503).

More specifically, when the verification data input unit 27 of the check-in device 20B acquires the biometric data inputted by a nearby user, the user verification unit 211 of the check-in device 20B receives that biometric data. The user verification unit 211 of the check-in device 20B then performs biometric verification by comparing and contrasting the biometric data of the nearby user acquired by the verification data input unit 27 with the biometric data in the nearby user list prepared in advance in the device storage unit 22 by the processing of step S502 described above. Thus, there is no need to access the server 10 and acquire the biometric data of the nearby user at the time of user verification, so the user verification can be completed faster, and it is possible to shorten the waiting time until the medical service is provided.

Next, the user verification unit 211 of the check-in device 20B determines whether or not the user verification was successful (step S504). If the user verification failed (No in step S504), this processing is ended, and the user is referred to a suitable medical clinic after taking time to consult with the receptionist at the check-in desk. On the other hand, if the user verification was successful (Yes in step S504), the processing proceeds to the next step S505.

Next, if the user verification was successful, the user verification unit 211 of the check-in device 20B requests that the service provision processor 212A of the check-in device 20B cause the treatment to be reflected in the electronic medical record of the nearby user who has been correctly verified (step S506).

Next, upon receiving this request from the user verification unit 211, the service provision processor 212A of the check-in device 20B acquires the electronic medical record of the nearby user who was correctly verified from the nearby user list prepared in advance in the device storage unit 22A, and gives medical guidance based on this acquired electronic medical record (step S506).

That is, the service provision processor 212A of the check-in device 20B causes the device display unit 24 to display a guidance screen for a treatment clinic according to the electronic medical record of the verified nearby user. Here again, since there is no need to access the server 10 and acquire the electronic medical record of a correctly verified nearby user after user verification is completed, it is possible to shorten the waiting time until the medical service can be provided.

As discussed above, with the verification system 1 according to the third embodiment, narrowing down to nearby users who are most likely to make use of the check-in device 20B in the medical facility allows the nearby user who will actually undergo user verification with that check-in device 20B to be identified quickly. Accordingly, user verification can also be completed faster, so it is possible to shorten the waiting time until the medical service is actually provided with the check-in device 20B in the medical facility. Furthermore, because biometric data about nearby users and so forth are prepared in advance in the check-in device 20B, there is no need to access the server 10 when actually performing user verification of nearby users. Therefore, user verification can be completed faster, so it is possible to further shorten the waiting time until medical service is actually provided.

### Other Embodiments

The embodiments given above are intended to facilitate an understanding of the present invention, and should not be construed as limiting the present invention. The present invention can be modified and improved without departing from the gist thereof, and the present invention encompasses equivalents thereof. In particular, the embodiments described below are also included in the present invention.

Nearby User List

In the embodiments described above, in the processing of step S301, step 401, and step S501, the server communication unit 15 of the server 10 may transmit user data (biometric data or the like) for all of the nearby users included in the nearby user list to the verification devices approached by those users (the vending machine 20, the POS terminal 20A, the check-in device 20B), or may transmit user data for only portion of nearby users, those obtained by narrowing down by specific conditions from all of the nearby users included in the nearby user list, to the verification devices approached by those users.

For example, the user selector 112 of the server 10 refers to history information stored in the server storage unit 12 and selects nearby users who have purchased products in the past from the vending machine 20 or the POS terminal 20A, or nearby users who have used the check-in device 20B in the past, from among all the nearby users included in the nearby user list. The server communication unit 15 of the server 10 may then transmit user data (biometric data or the like) for nearby users who have used a verification device in the past, to that verification device. Consequently, when identifying nearby users who will actually undergo user verification with the verification devices in various facilities, the search is narrowed down to nearby users who are most likely to actually use those verification devices based on past usage, so user verification can be completed faster.

Also, in the first embodiment above, in the processing of step S301, step 401, and step S501 described above, the server communication unit 15 of the server 10 can also transmit data based on the usage status of the verification device in transmitting user data (biometric data or the like) about nearby users included in the nearby user list to the verification devices approached by these users.

For instance, the server communication unit 15 of the server 10 can also refer to device information stored by the server storage unit 12 and transmit user data (biometric data or the like) about nearby users included in the nearby user list, as long as nobody has selected or purchased the product (available state).

User Selector

In the above embodiments, an example was described in which the user selector 112 of the server 10 selected on-site users who were located in the usage facility from among all the member users by the use of a first wireless communication (that is, wireless communication with a user terminal by the access point 5 in the above embodiments), and then selected nearby users who had approached a verification device from among all the previously selected on-site users by the use of a second wireless communication (that is, wireless communication with the user terminal by the verification device in the above embodiments, being short-range wireless communication in which the radio wave reception area was smaller than in the first wireless communication), but the present invention is not limited to this.

For instance, by omitting the selection of on-site users (without narrowing down in steps), it is also possible to select only those nearby users who have approached a verification device in the usage facility from among all the member users by the use of short-range wireless communication.

Also, for example, by omitting the selection of nearby users (without narrowing down in steps), it is also possible to select only those on-site users located within the usage facility from among all member users by the use of wireless communication. In this case, the server communication unit 15 of the server 10 may transmit in advance user data (biometric data or the like) about the on-site users included in the on-site user list to all verification devices in the usage facility.

In the above embodiments, an example was given in which the user selector 112 of the server 10 selected an on-site user located in the facility from among all the member users by the use of wireless communication by WiFi, but the present invention is not limited to this.

For example, on-site users may be selected by the use of GPS (Global Positioning System) communication using a positioning satellite or the like, or by the use of short-range wireless communication by BLE. Also, for example, on-site users may be selected by holding an IC card or the like in the possession of the user up to a card reader installed near the entrance of the usage facility.

Also, in the above embodiments, an example was given in which the user selector 112 of the server 10 selected a nearby user who had approached the verification device from among all the on-site users previously selected by the use of short-range wireless communication by BLE, but the present invention is not limited to this.

For instance, nearby users may be selected by the use of GPS (Global Positioning System) communication using positioning satellites, or by the use of infrared communication, or by the use of short-range wireless communication by NFC (Near-field Communication). Also, for example, nearby users may be selected by holding an IC card or the like in the possession of the user up to a card reader installed in the vicinity of a verification device.

Other Facilities

In the above embodiments, the shopping facility 3 and the vending machine 20, the shopping facility 3 and the POS terminal 20A, and the medical facility 3B and the check-in device 20B were given as examples of a combination of a facility and a verification device, but the present invention is not limited to this. For instance, other examples of a combination of a facility and a verification device are applicable, such as a lodging facility and a check-in device, a movie theater and a check-in device, an office facility and a check-in device, a game center and a game device, an amusement park and an attraction admission management device (priority admission ticketing device), a stadium or other such sports facility and an admission management device, a transportation facility (airport, station, bus stop, etc.) and a ticket gate device, and so forth. Thus, the present invention is favorably applied to any of various types of verification device that may be used by any one of numerous specified nearby users present in the vicinity of the facility. Also, the “facility” in the present invention may be any one having a space in which a verification device can be installed, and when the ticket gate device (verification device) of the present invention is installed on an airplane, ship, train, bus, or other such mode of transportation, that mode of transportation shall function as the facility.

Server

In the above embodiments, the verification system 1 comprising one server 10 was described as an example of a server, but the verification system 1 may instead comprise a plurality of servers 10 as an example of the server. For instance, the functions may be distributed by dividing up the server 10 into a verification server and a management server or the like.

User Terminal

In the above embodiments, when a user terminal 50 enters the facility area 6, or when a short-distance wireless connection is established with various kinds of verification device, the fact that the facility area 6 has been entered, or that a short-distance wireless connection has been established with the various verification devices may be displayed as a notification on the terminal display unit 54 of the user terminal 50, either automatically or by an instruction from the user. Consequently, the user can check the terminal display unit 54 to find out before verification whether he is in a state that can be properly verified by the various verification devices. The notification mode is not limited to display on the terminal display unit 54, and may instead consist of the vibration of a vibrator (an eccentric motor, etc.) incorporated into the user terminal 50, or the output of audio from an audio output unit (a speaker, etc.).

### REFERENCE SIGNS LIST

1 Verification system
2 Communication network
3 Shopping facility
4 Communication network
5 Access point
6 Facility area
7 Device area
10 Server
11 Server controller
12 Server storage unit
13 Server input unit
14 Server display unit
15 Server communication unit
20 Vending machine
20A POS terminal
20B Check-in device
21 Device controller
22 Device storage unit
23 Device operation unit
24 Device display unit
25 Device communication unit
26 Audio output unit
27 Verification data input unit
28 Charge settlement unit
29 Product storage unit
30 Reader
50 User terminal
51 Terminal controller
52 Terminal storage unit
53 Terminal operation unit
54 Terminal display unit
55 Terminal communication unit
111 Management unit
112 User selection unit
211 User verification unit
212 Product provision processor
212A Service provision processor
213 Screen display processor

1. A verification system for performing biometric verification with a verification device in a usage facility, said verification system comprising a server and a verification device,
the server comprising:
a storage unit that stores user information in which biometric data for identifying individuals has been preset in association with each user;
a user selector that selects a user located in the usage facility from among the plurality of users included in the user information, when a user terminal in the possession of a user who has entered the usage facility is connected with a communication network so as to allow the exchange of information; and
a communication unit that acquires biometric data associated with the selected user from the user information and transmits this data via the communication network to the verification device in the usage facility where the biometric verification is to be performed, and
the verification device comprising:
a device communication unit that receives biometric data associated with the user selected by the user selector from the server via the communication network;
a verification data input unit that acquires biometric data about the user located in the usage facility; and
a user verification unit that performs biometric verification by comparing the biometric data received by the device communication unit with the biometric data acquired by the verification data input unit.

2. A verification system for performing biometric verification with a verification device in a usage facility, said verification system comprising a server and a verification device,
the server comprising:
a storage unit that stores user information in which biometric data for identifying individuals has been preset in association with each user;
a user selector that selects a user in the vicinity of the verification device from among the plurality of users included in the user information, when a user terminal in the possession of a user in the vicinity of a verification device in the usage facility is connected with a communication network so as to allow the exchange of information; and
a communication unit that acquires biometric data associated with the selected user from the user information and transmits this data via the communication network to the verification device in the usage facility where the biometric verification is to be performed, and
the verification device comprising:
a device communication unit that receives biometric data associated with the user selected by the user selector from the server via the communication network;
a verification data input unit that acquires biometric data about the user in the vicinity of the verification device; and
a user verification unit that performs biometric verification by comparing the biometric data received by the device communication unit with the biometric data acquired by the verification data input unit.

3. A verification system for performing biometric verification with a verification device within a usage facility, said verification system comprising a server and a verification device,
the server comprising:
a storage unit that stores user information in which biometric data for identifying individuals has been preset in association with each user;
a user selector that selects a user located in the usage facility from among the users included in the user information, when a user terminal in the possession of a user who has entered a facility area corresponding to the usage facility is connected with a communication network so as to allow the exchange of information, and selects a user in the vicinity of the verification device from among the previously selected users located in the usage facility, when a user terminal in the possession of a user who has entered a device area corresponding to a verification device in the usage facility is connected with a communication network so as to allow the exchange of information; and
a communication unit that acquires biometric data associated with the user selected by the user selector from the user information and transmits this data via the communication network to the verification device in the usage facility where the biometric verification is to be performed, and
the verification device comprising:
a device communication unit that receives biometric data associated with the user selected by the user selector from the server via the communication network;
a verification data input unit that acquires biometric data about the user in the vicinity of the verification device; and
a user verification unit that performs biometric verification by comparing the biometric data received by the device communication unit with the biometric data acquired by the verification data input unit.

4. The verification system according to claim 1,
wherein the communication unit transmits the biometric data acquired from the user information before biometric verification is performed by the verification device.

5. The verification system according to claim 1,
wherein history information related to the verification devices used by users in the past is associated with each user and included in the user information stored by the storage unit,
the user selector selects a user who has used the verification device in the past from among users located in the selected usage facility or users in the vicinity of the verification device in the selected usage facility, and
the communication unit acquires biometric data associated with users who have used the selected verification device in the past from the user information, and transmits this data via the communication network to the verification device where the biometric verification is to be performed.

6. The verification system according to claim 1,
wherein the storage unit stores device information in which a user's usage status is included in association with each verification device, and
the communication unit transmits the biometric data acquired from the user information on the basis of the usage status of the verification device.

7. A server, comprising:
a storage unit that stores user information in which biometric data for identifying individuals has been preset in association with each user;
a user selector that selects a user located in the usage facility from among the plurality of users included in the user information, when a user terminal in the possession of a user who has entered the usage facility is connected with a communication network so as to allow the exchange of information; and
a communication unit that acquires biometric data associated with the selected user from the user information and transmits this data via the communication network to the verification device in the usage facility where the biometric verification is to be performed.

8. A server, comprising:
a storage unit that stores user information in which biometric data for identifying individuals has been preset in association with each user;
a user selector that selects a user in the vicinity of the verification device from among users included in the user information, when a user terminal in the possession of a user in the vicinity of a verification device in the usage facility is connected with a communication network so as to allow the exchange of information; and
a communication unit that acquires biometric data associated with the selected user from the user information and transmits this data via the communication network to the verification device in the usage facility where the biometric verification is to be performed.

9. A server, comprising:
a storage unit that stores user information in which biometric data for identifying individuals has been preset in association with each user;
a user selector that selects a user located in the usage facility from among the users included in the user information, when a user terminal in the possession of a user who has entered a facility area corresponding to the usage facility is connected with a communication network so as to allow the exchange of information, and selects a user in the vicinity of the verification device from among the previously selected users located in the usage facility, when a user terminal in the possession of a user who has entered a device area corresponding to a verification device in the usage facility is connected with a communication network so as to allow the exchange of information; and
a communication unit that acquires biometric data associated with the user in the vicinity of the selected verification device from the user information and transmits this data via the communication network to the verification device where the biometric verification is to be performed.
